(19) United States
(12) Patent Application Publication
(10) Pub. No.: US 2005/0041540 A1
(43) Pub. Date: Feb. 24, 2005

(54) Optical pickup and disc drive

(76) Inventor: Hidetoshi Tanaka, Chiba (JP)

Correspondence Address: RADER FISHMAN & GRAUER PLLC, LION BUILDING, 1233 20TH STREET N.W., SUITE 501, WASHINGTON, DC, 20036, US

(21) Appl. No.: 10/873,480

(22) Filed: Jun. 23, 2004

(30) Foreign Application Priority Data
Jul. 16, 2003 (JP) P2003-275317

(51) Int. Cl. G11B 7/00

(52) U.S. Cl. 369/44.15; 369/44.22; 369/44.32

(57) ABSTRACT

In order to ensure favorable sensitivity at the time of tilt driving and realize reduction in size, there is provided an optical pickup and a disc drive having therein an optical lens drive including a stationary block fixed to a moving base, a movable block operated in a focusing direction, a tracking direction and a tilting direction and for holding said objective lens, a supporting spring for connecting the stationary block and the movable block, a coil assembly having therein a focusing coil, tracking coils and tilt coils to be respectively energized when said movable block is operated in the focusing direction, the tracking direction, and the tilting direction connected together, and magnets constituting a magnetic circuit together with each of said coils, and the tilt coils are disposed at a position where at least a part thereof overlaps with the focusing coil in the focusing direction.

### CROSS REFERENCES TO RELATED APPLICATIONS

The present document is based on Japanese Priority Document JP 2003-275317, filed in the Japanese Patent Office on Jul. 16, 2003, the entire contents of which being incorporated herein by reference.

### BACKGROUND OF THE INVENTION

1. Field of the Invention

The present invention relates to an optical pickup and to a disc drive. More particularly, the present invention relates to a technical field of an optical pickup having an objective lens drive, in which a movable block is supported by a stationary block through a supporting spring, and to a disc drive having this optical pickup.

2. Description of Related Art

There is a disc drive for performing recording and reproduction of information signals on a disklike recording medium, such as an optical disc and a magneto-optical disc. Such a disc drive is provided with an optical pickup that is moved in a radial direction of a disklike recording medium and that irradiates laser light on the disklike recording medium.

The optical pickup is provided with an objective lens drive. An objective lens held by a movable block of the objective lens drive is operated by the objective lens drive to move in a focusing direction, which is a direction of bringing the objective lens away from or closer to a recording surface of a disklike recoding medium, thereby to perform a focusing adjustment. Also, the objective lens is operated by the objective lens drive to move in a tracking direction, which is a substantially radial direction of the disklike recording medium, thereby to perform a tracking adjustment. Thus, a spot of laser light irradiated onto the disklike recording medium through the objective lens is converged to a recording track of the disklike recording medium.

It is general that the focusing adjustment and the tracking adjustment are performed by the objective lens drive in the optical pickup in this manner. However, in recent years, to improve a laser light spot's ability to follow a recording track, there has been developed an objective lens drive called a tri-axial actuator enabling tilted movement of the movable block with respect to a recording surface of a disklike recording medium and an adjustment on an occurrence of axial run-out or the like in addition to adjustments in two axial directions, which are the focusing adjustment and the tracking adjustment.

The objective lens drive called the tri-axial actuators includes, for example, a turning block turnably supported by a stationary base (a stationary block), a holder attached to the turning block, and a bobbin (a movable block) supported by the holder through a wire (see, for instance, Patent Document 1). A focusing coil and tracking coils are attached to the bobbin. Tilt coils are attached to the turning block. The tilt coils are placed on the lower sides the focusing coils and the tracking coils. A first magnetic circuit is constituted by the focusing coil, the tracking coils, a pair of first magnets and first inner and outer yokes. A second magnetic circuit is constituted by the tilt coils, a pair of second magnets and second inner and outer yokes.

When the focusing coil or the tracking coils are energized, the bobbin, to which the objective lens is attached by a force generated in the first magnetic circuit, is operated in the focusing direction or the tracking direction. When the tilt coils are energized, the turning block is operated in a tilting direction (a direction in which the turning block is turned with respect to the stationary base by a force generated in the second magnetic circuit). The bobbin is operated in the tilting direction as this operation is performed by the turning block.

[Patent Document 1] U.S. Pat. No. 6,295,255 corresponding to Japanese Patent Application Publication No. 2000-11414 Official Gazette.

However, in the above-mentioned objective lens drive of the conventional optical pickup, the focusing coil and the tracking coils are provided in the bobbin, while the tilt coils are provided in the turning block. The two magnetic circuits are separately constituted. Thus, this objective lens drive has problems in that the number of components is large, and that the manufacturing cost thereof is high.

Thus, the following objective lens drive has been provided as that constituted with the reduced number of components.

This objective lens drive has a stationary block and a movable block supported. by the stationary block through a supporting spring capable of being displaced in the focusing direction, the tracking direction, and the tilting direction. A coil assembly, in which a focusing coil, tracking coils and tilt coils are connected to one another, is provided in the movable block. Paired and opposed magnets are disposed at positions, which are opposite to each other, across the coil assembly, respectively (see FIGS. 11 and 12).

The coil assembly a comprises, for instance, the focusing coil b formed like a laterally-long hollow substantially-rectangle, the tracking coils c, c, . . . attached onto the outer peripheral surface of the focusing coil b to be laterally separated from each other, and the tilting coils d, d attached onto the bottom surface of the focusing coil b to be laterally separated from each other, and is provided as a part of the movable block having an objective lens. The coil assembly a is located to be sandwiched by a pair of magnets e, e attached to inner surfaces of a yoke (not shown), respectively (see FIG. 12).

In the objective lens drive, the focusing coil b, the tracking coils c, c, . . . , and the tilt coils d, d are connected and provided as the coil assembly a, and additionally, only one magnetic circuit corresponding to the coil assembly a is required. Thus, the number of components is significantly reduced.

However, in such a conventional objective lens drive, the tilt coils d, d are attached onto the bottom surface of the focusing coil b. Thus, an objective lens having a large weight is placed above the coil assembly a, so that the conventional objective lens drive has an advantage of capability thereof to ensure a favorable balance of the movable block. However, the conventional objective lens drive has a problem in that a rate of change in the sensitivity at the time of performing tilt driving is large.

That is, as illustrated in FIG. 13, magnetic flux densities of the magnets e, e respectively placed at the opposite sides across the coil assembly a are set to be high at a central part of each of the magnets e, e and as to drastically become low at places away than a predetermined distance from the central part thereof. Usually, in a case where the tilt coils d, d are attached onto the bottom surface of the focusing coil b, importance is put on the sensitivity during a focusing operation, so that the position of the focusing coil b is set at a position corresponding to the place at which the magnetic flux density is high. Thus, the tilt coils d, d are highly likely to be placed at positions corresponding to a position, at which the magnetic flux density drops drastically, or to a position at which the magnetic flux density is drastically reduced.

Therefore, in the case where the tilt coils d, d are placed at such positions as described above, respectively, extreme reduction in the sensitivity at the time of performing the tilt driving occurs especially when the movable block is operated in the focusing direction (downwardly). This results in reduction in reliability of an operation during the tilt driving.

Further, in the case where the tilt coils d, d are attached to the bottom surface of the focusing coil b, the thickness of the coil assembly a increases by the thickness of the attached member. Thus, the conventional objective lens drive has a problem in that reduction in the thickness thereof is hindered.

Such problems of the reduction in the sensitivity during tilt driving, and hindrance to the reduction in the thickness similarly occur even in a case where the tilt coils d, d are attached to the top surface of the focusing coil a.

Additionally, in the above-mentioned objective lens drive having the turning block and the two magnetic circuits, the tilt coils are downwardly placed by being separated from the focusing coil. Thus, the sensitivity thereof at the time of performing the tilt driving is more extremely reduced, and the thickness of the entire objective lens drive becomes larger.

### SUMMARY OF THE INVENTION

Accordingly, an optical pickup and a disc drive according to the present invention are aimed for overcoming the above-mentioned problems, of ensuring favorable sensitivity during the tilt driving, and of reducing the thickness thereof.

The present invention provides an optical pickup and a disc drive having an objective lens drive provided with a stationary block, a movable block, a supporting spring, a coil assembly and magnets. In the objective lens drive, the stationary block is fixed to a moving base; the movable block is operated in a focusing direction that is a direction of bringing the movable block away from or closer to a recording surface of a disklike recording medium, in a tracking direction that is a substantially radial direction of the disklike recording medium, and in a tilting direction that is an axial direction of an axis perpendicular to both the focusing direction and the tracking direction, and is operative to hold the objective lens; the supporting spring connects the stationary block and the movable block; the coil assembly has therein a focusing coil, tracking coils and tilt coils to be respectively energized when the movable block is operated in the focusing direction, the tracking direction, and the tilting direction connected together; and the magnets constitutes a magnetic circuit together with each of the coils. In the drive, the tile coils are disposed at a position where at least a part of the tilt coils overlaps with the focusing coil in the focusing direction.

Therefore, in the optical pickup and the disc drive of the present invention, the tilt coils are placed to correspond to a part at which a magnetic flux density of each of the magnets is high.

The optical pickup according to the present invention has the moving base, which is moved in a radial direction of a disklike recording medium mounted on a disc table, and the above-described objective lens drive disposed on the moving base

Especially, even in a state in which the movable block is operated in the focusing direction, reduction in the sensitivity at the time of performing the tilt driving does not occur. The reliability of an operation at the time of performing the tilt driving can be enhanced.

Further, the tilt coils are disposed at the position where at least a part thereof overlaps with the focusing coil in the focusing direction. As a result, the thickness of the coil assembly decreases by the overlapping portion. Thus, the thickness of the optical pickup can be reduced.

In the optical pickup according to another aspect of the present invention, the tilt coils are attached onto an inner peripheral surface of the focusing coil. Thus, the focusing coil can be placed closely to the magnets. Consequently, the sensitivity at the time of performing the focusing driving can be enhanced.

In the optical pickup according to another aspect of the present invention, the tilt coils are attached onto an outer peripheral surface of the focusing coil. Thus, the tilt coils can be placed closely to the magnets. Consequently, the sensitivity at the time of performing the tilt driving can be enhanced.

Further, it is possible to have the coil assembly can be performed by sequentially attaching the tilt coils onto the outer peripheral surface of the focusing coil, and then attaching the tracking coils onto the outer surfaces of the tilt coils or the focusing coil. Thus, an operation of assembling the coil assembly can easily be performed. Consequently, workability can be improved.

In the optical pickup according to another aspect of the present invention, a pair of coil assemblies are disposed to be separated from each other in the tracking direction. A rising mirror is disposed in a space formed between the pair of coil assemblies. Thus, an optical path of laser light can be upwardly moved and brought closer to the movable block. Consequently, the thickness of the optical pickup can be reduced.

The disc drive according to the present invention has the disc table, on which the disklike recording medium is loaded, and the optical pickup as described above for irradiating laser light onto the disklike recording medium, which is mounted on the disc table, through the objective lens

Therefore, even in a state in which the movable block is operated in the focusing direction, reduction in the sensitivity at the time of performing the tilt driving does not occur. The reliability of an operation at the time of performing the tilt driving can be enhanced.

Further, the tilt coils are disposed at the position where at least a part thereof overlaps with the focusing coil in the focusing direction. As a result, the thickness of the coil assembly decreases by the overlapping portion. The thickness of the disc drive can be reduced.

In the disc drive according to another aspect of the present invention, the tilt coils are attached onto the inner peripheral surface of the focusing coil. Thus, the focusing coil can be placed closely to the magnets. Consequently, the sensitivity at the time of performing the focusing driving can be enhanced.

In the disc drive according to another aspect of the present invention, the tilt coils are attached onto the outer peripheral surface of the focusing coil. Thus, the tilt coils can be placed closely to the magnets. Consequently, the sensitivity at the time of performing the tilt driving can be enhanced.

Moreover, it is possible to have the coil assembly by sequentially attaching the tilt coils onto the outer peripheral surface of the focusing coil, and then attaching the tracking coils onto the outer surfaces of the tilt coils or the focusing coil. Thus, an operation of assembling the coil assembly can easily be performed. Consequently, workability can be improved.

In the disc drive according to another aspect of the present invention, the pair of coil assemblies are disposed to be separated from each other in the tracking direction. The rising mirror is disposed in a space formed between a pair of coil assemblies. Thus, the optical path of laser light can be upwardly moved and brought closer to the movable block. Consequently, the thickness of the disc drive can be reduced.

### BRIEF DESCRIPTION OF THE DRAWINGS

The above and other objects, features and advantages of the present invention will become more apparent from the following description of the presently preferred exemplary embodiments of the invention taken in conjunction with the accompanying drawings, in which:

FIG. 1 shows a best mode for carrying out the invention, together with FIGS. 2 to 10, and is a schematic plan view illustrating a disc drive;

FIG. 2 is an enlarged perspective view illustrating an objective lens drive;

FIG. 3 is an enlarged perspective view illustrating a coil assembly;

FIG. 4 is an enlarged plan view illustrating positional relationship among the coil assembly and magnets;

FIG. 5 is a conceptual view illustrating relationship between the position of the coil assembly and a magnet flux density of the magnet;

FIG. 6 shows a first modification of the coil assembly, together with FIG. 7, and is an enlarged plan view illustrating positional relationship among the coil assembly and the magnets;

FIG. 7 is an enlarged front view partly cross-sectionally illustrating the coil assembly, together with the magnet:

FIG. 8 shows a second modification of the coil assembly, together with FIGS. 9 and 10, and is an enlarged plan view illustrating positional relationship among the coil assembly and the magnets;

FIG. 9 is a conceptual view illustrating a part of the objective lens drive using the coil assembly;

FIG. 10 is an enlarged plan view illustrating a coil assembly, in which positions of the focusing coil and the tilt coil are replaced with each other, together with the magnet;

FIG. 11 is an enlarged perspective view illustrating a coil assembly provided in a conventional optical pickup;

FIG. 12 is an enlarged plan view illustrating positional relationship among a conventional coil assembly and magnets; and

FIG. 13 is a conceptual view illustrating relationship between a position of the conventional coil assembly and a magnetic flux density of the magnet.

### DESCRIPTION OF THE PREFERRED EMBODIMENTS

Hereinafter, preferred embodiments of an optical pickup and a disc drive of the present invention are described with reference to the accompanying drawings.

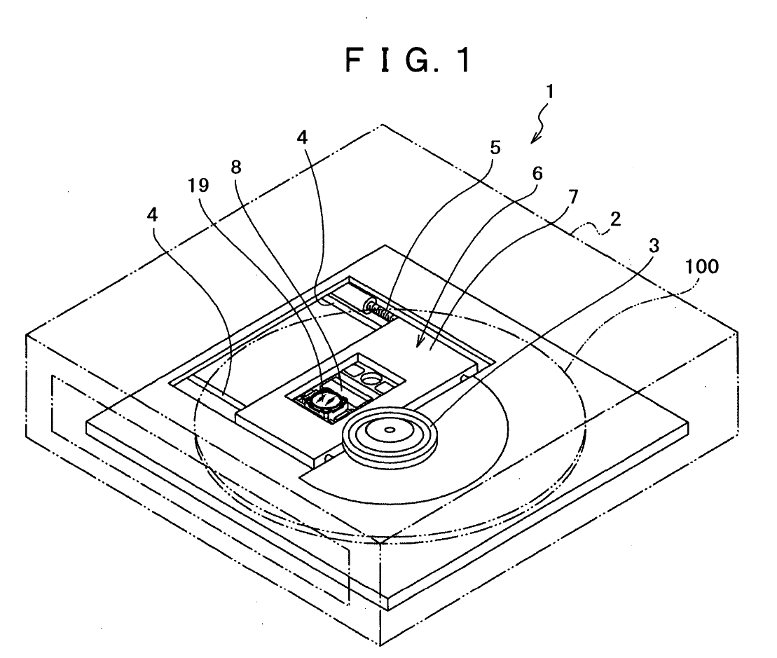

A disc drive 1 is configured so that each of required members and mechanisms is disposed in an outer casing 2 (see FIG. 1), and that a disc insertion opening (not shown) is formed in the outer casing 2.

A chassis (not shown) is disposed in the outer casing 2. A disc table 3 is fixed to a motor shaft of a spindle motor mounted on the chassis.

Parallel guide shafts 4, 4 are attached to the chassis, and a lead screw 5 to be rotated by a feed motor (not shown) is supported by the chassis.

An optical pickup 6 has a moving base 7, required optical components provided on the moving base 7, and an objective lens drive 8 disposed on the moving base 7. Bearing portions 7a, 7b provided at both end portions of the moving base 7 are slidably supported by the guide shafts 4, 4 (see FIG. 1). A nut member (not shown) provided on the moving base 7 is screwed into the lead screw 5. When the lead screw 5 is rotated by the feed motor, the nut member is fed in a direction corresponding to the direction of rotation of the lead screw 5. The optical pickup 6 is moved in a radial direction of a disklike recording medium 100 mounted on the disc table 3.

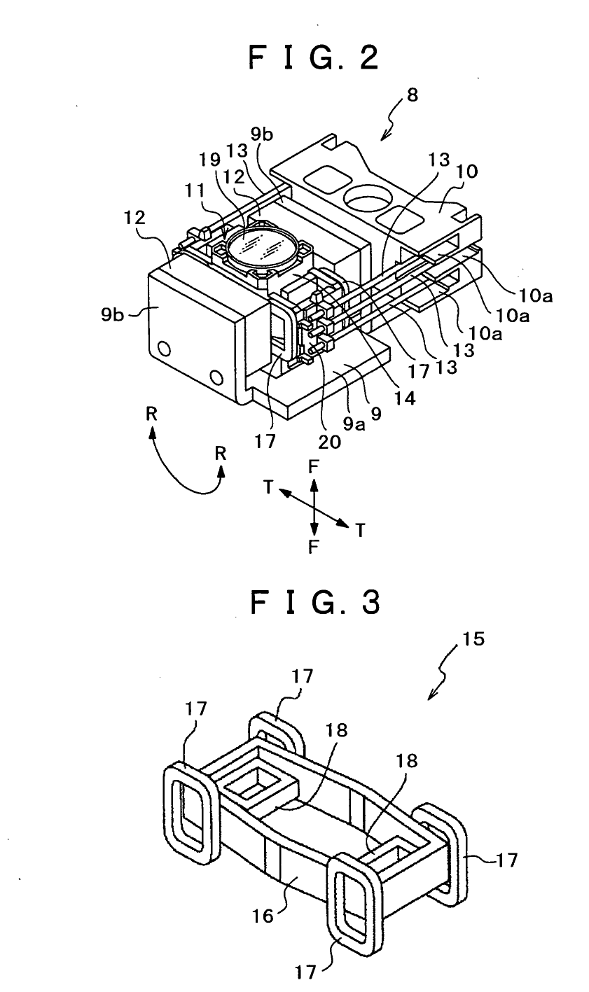

The objective lens drive 8 has a base member 9, a stationary block 10, and a movable block 11 to be operated with respect to the stationary block 10 (see FIG. 2).

The base member 9 comprises a base portion 9a, which is attached to the moving base 7 and obtained by integrally forming parts thereof of a magnetic metal material, and yoke portions 9b, 9b erected and bent at right angles from both end parts of the base portion 9a. Magnets 12, 12 are attached to surfaces opposing each other of the yoke portions 9b, 9b, respectively.

The stationary block 10 is fixed onto the moving base 7 and has three spring attaching portions 10a, 10a, . . . , provided at each of left and right sides to be separated from one another in an up-and-down direction. A circuit board (not shown) is attached to the stationary block 10.

One end portion of each of three supporting springs 13, 13, . . . , is attached at each of left and right sides of one of the three spring attaching portions 10a, 10a, . . . , of the stationary block 10. The other end portion of each of the supporting springs 13, 13, . . . , is connected to the circuit board that is attached to the stationary block 10. A driving current is supplied from a power supply (not shown) through the circuit board to the supporting springs 13, 13,

The movable block 11 has a bobbin 14 to which a coil assembly 15 is attached.

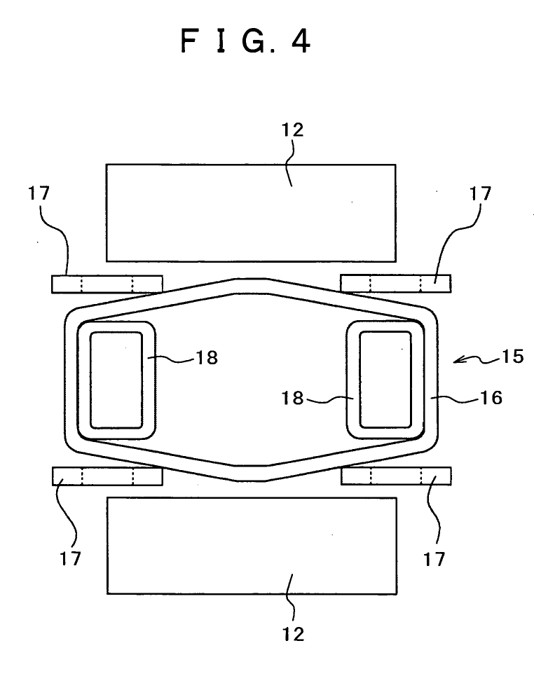

The coil assembly 15 is constituted by connecting a focusing coil 16, tracking coils 17, 17, . . . , and tilt coils 18, 18 (see FIGS. 3 to 5).

The focusing coil 16 is formed like a laterally-long hollow substantially-rectangle so that the axial direction thereof is an up-and-down direction. The tracking coils 17, 17, . . . , are each formed like a thin ring, whose axial direction is a front-rear direction, and attached to an outer peripheral surface of the focusing coil 16 to be separated from one another in the front-rear direction. The tilt coils 18, 18 are each formed like a hollow substantially-rectangle so that the axial direction thereof is an up-down direction, and are arranged in the focusing coil 16 to be laterally separated from one another. Thus, the tilt coils 18, 18 are attached to an inner peripheral surface of the focusing coil 16.

An objective lens 19 is attached to and held at a top end portion of the bobbin 14 (See FIG. 2).

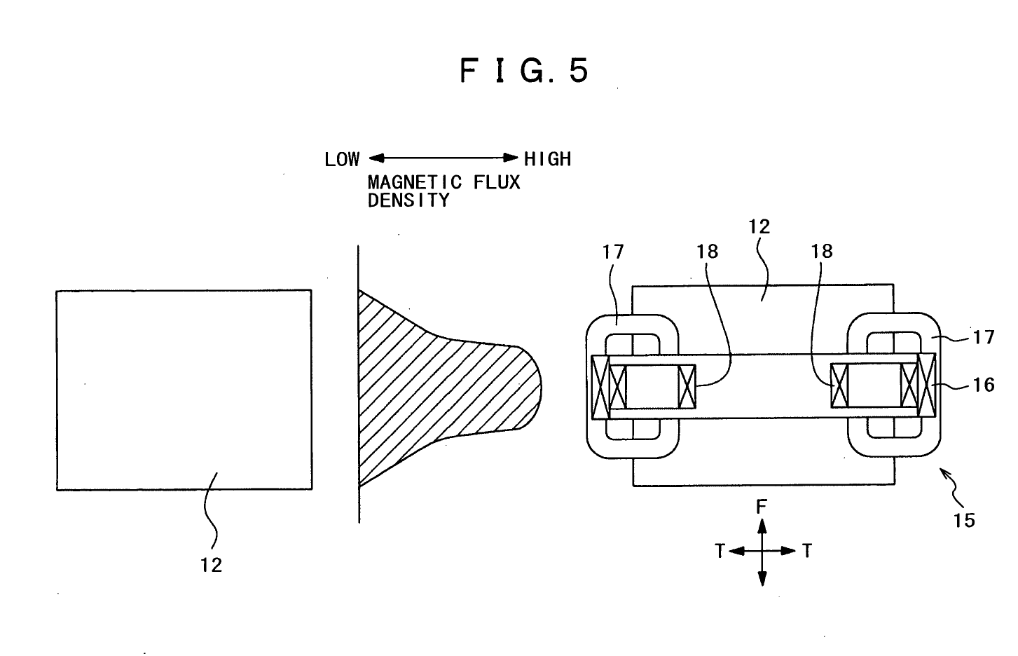

Support boards 20, 20 are attached to both left and right side surface portions of the bobbin 14. The other end portion of each of the supporting springs 13, 13, is attached to one of the support boards 20, 20. Thus, the movable block 11 is connected to the stationary block 10 through the supporting springs 13, 13, . . . , and held floatingly, and placed between the magnets 12, 12 attached to the yoke portions 9b, 9b of the base member 9. At that time, at a neutral position of the movable block 11 in the focusing direction (the up-down direction), that is, at a position in a state in which no focusing operation is performed, the focusing coil 16 is placed to correspond to a central portion in the up-down direction of each of the magnets 12, 12. The central portions of these magnets 12, 12 are parts at which the magnetic flux density thereof is highest (see FIG. 5). Thus, the tilt coils 18, 18 are located at a position substantially the same as that of the focusing coil 16 in the focusing direction. The tilt coils 18, 18 are placed to correspond to the central portions at which the magnets 12, 12 have highest magnetic flux densities.

Driving currents are supplied from the power supply to the focusing coil 16, the tracking coils 17, 17, and the tilt coils 18, 18, through the circuit board, the supporting springs 13, 13, . . . , and the support boards 20, 20, which are attached to the stationary block 10.

When a driving current is supplied to the focusing coil 16, a thrust acting in a predetermined direction is generated according to the direction of the driving current flowing through the focusing coil 16. The movable block 11 is operated toward the stationary block 10 in an F-F direction indicated in FIGS. 2 and 5, that is, the focusing direction that is the direction of bringing the movable block 11 away from or closer to a recording surface of the disklike recording medium 100 mounted on the disc table 3.

When driving currents are supplied to the tracking coils 17, 17, . . . , a thrust acting in a predetermined direction is produced according to the direction of each of the driving currents flowing through the tracking coils 17, 17, . . . . The movable block 11 is operated toward the stationary block 10 in the T-T direction indicated in FIGS. 2 and 5, that is, the tracking direction that is the substantially radial direction of the disklike recording medium 100 mounted on the disc table 3.

When driving currents are supplied to the tilt coils 18, 18, a thrust acting in a predetermined direction is generated according to the direction of each of the driving currents flowing through the tilt coils 18, 18, The movable block 11 is operated toward the stationary block 10 in an R-R direction indicated in FIGS. 2 and 5, that is, the tilting direction that is an axial direction of an axis perpendicular to both the focusing direction and the tracking direction.

In a case where the movable block 11 is operated in the focusing direction, the tracking direction, or the tilting direction, the supporting springs 13, 13, . . . , are elastically deformed.

In a case where the disc table 3 is rotated by rotation of the spindle motor in the disc drive 1 constituted as described above, the disklike recording medium 100 mounted on the disc table 3 is rotated. Simultaneously, the optical pickup 6 is moved in the radial direction of the disklike recording medium 100, so that a recording operation or a reproducing operation is performed on the disklike recording medium 100.

In a case where a driving current is supplied to the focusing coil 16 during this recoding operation and the reproducing operation, the movable block 11 of the objective lens drive 8 is operated toward the stationary block 10 in the focusing direction F-F indicated in FIGS. 2 and 5, as described above. Then, a focusing adjustment is performed so that a spot of laser light outputted from a semiconductor laser (not shown) provided in the moving base 7 and irradiated through the objective lens 19 is converged onto a recording track in the disklike recording medium 100. Further, in a case where driving currents are supplied to the tracking coils 17, 17, . . . , as described above, the movable block 11 of the objective lens drive 8 is operated toward the stationary block 10 in the tracking direction T-T indicated in FIGS. 2 and 5. Then, a tracking adjustment is performed so that a spot of laser light outputted from the semiconductor laser and irradiated through the objective lens 19 is converged onto a recording track in the disklike recording medium 100.

During the recording operation and the reproducing operation are performed on the disklike recording medium 100, a tilting adjustment is simultaneously performed in addition to the focusing adjustment and tracking adjustment described above. This tilting adjustment is performed by turning the movable block 11 in the tilting direction R-R indicated in FIGS. 2 and 5, in such a way as to follow the disklike recording medium 100, for example, when axial run-out or the like occurs during the disklike recording medium 100 rotates.

As described in the foregoing description, in the disc drive 1, the tilt coils 18, 18 are disposed at a position overlapping with the focusing coil 16 in the focusing direction. Thus, the tilt coils 18, 18 are placed at a position corresponding to a position at which the magnetic flux density of each of the magnets 12, 12 is high. Especially, even in a state in which the movable block 11 is operated in the focusing direction, the reliability of an operation at the time of performing the tilt driving can be improved without reducing the sensitivity thereof during the tilt driving.

Also, the tilt coils 18, 18 are disposed at a position overlapping with the focusing coil 16 in the focusing direction. As a result, the thickness of the coil assembly 15 decreases by the overlapping amount. Thus, the thickness of the optical pickup 6 can be decreased.

Incidentally, in the foregoing description, the example of disposing the entire tilt coils 18, 18 at the position overlapping with the focusing coil 16 in the focusing direction has been described. However, it is possible to place a part of the tilt coils 18, 18 at the position overlapping with the focusing coil 16 in the focusing direction, and to arrange another part of the tilt coils 18, 18 to protrude upwardly from the top surface of the focusing coil 16 or downwardly from the bottom surface thereof so as to form the coil assembly 16.

Further, in the disc drive 1, the tilt coils 18, 18 are attached onto the inner peripheral surface of the focusing coil 16. Thus, the focusing coil 16 can be placed closely to the magnets 12, 12. Consequently, the sensitivity thereof at the time of performing the focusing driving can be enhanced.

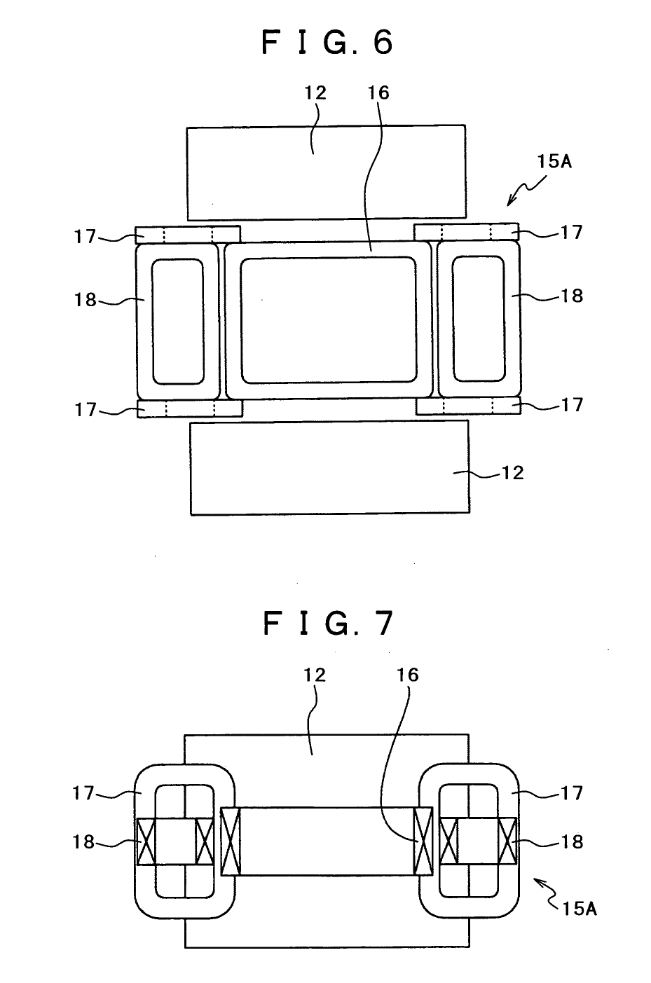

Next, a first modification of the coil assembly is described (see FIGS. 6 and 7). It is noted that, as compared with the above-mentioned coil assembly 15, a coil assembly 15A according to the first modification differs therefrom only in that the tilt coils are attached onto an outer peripheral surface of the focusing coil, and that the tracking coils are attached onto outer peripheral surfaces of the tilt coils and the focusing coils. Therefore, only portions of the coil assembly 15A, which differ from the above-mentioned coil assembly 15 in comparison therewith, are described in detail. The remaining portions thereof are designated by the same reference characters as those used for designating similar parts of the coil assembly 15. Thus, the description of the remaining portions thereof is omitted.

The coil assembly 15A is constituted by connecting the focusing coil 16, the tracking coils 17, 17, . . . , and the tilt coils 18, 18 to one another. The tilt coils 18, 18 are attached to both left and right side faces of the outer peripheral surface of the focusing coil 16. The tracking coils 17, 17, . . . , are attached at a place extending over a front face and a rear face of the outer peripheral surfaces of the tilt coils 18, 18 and both left and right end portions of the focusing coil 16.

In the coil assembly 15A, the tilt coils 18, 18 are placed outside the focusing coil 16, so that the sensitivity at the time of performing the tilt driving can be improved.

Further, it is sufficient to sequentially attach the tilt coils 18, 18 onto the outer peripheral surface of the focusing coil 16, and then attach the tracking coils 17, 17, . . . , onto the outer surfaces of the tilt coils 18, 18 and the focusing coil 16. Thus, an operation of assembling the coil assembly 15A can easily be performed. Consequently, the workability can be improved.

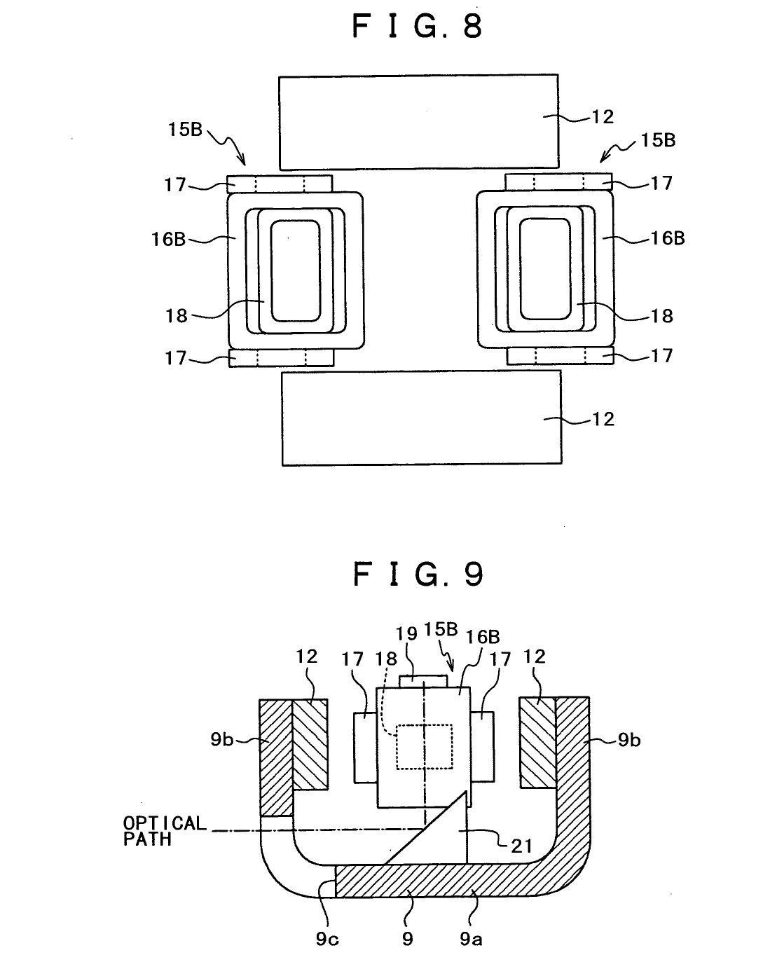

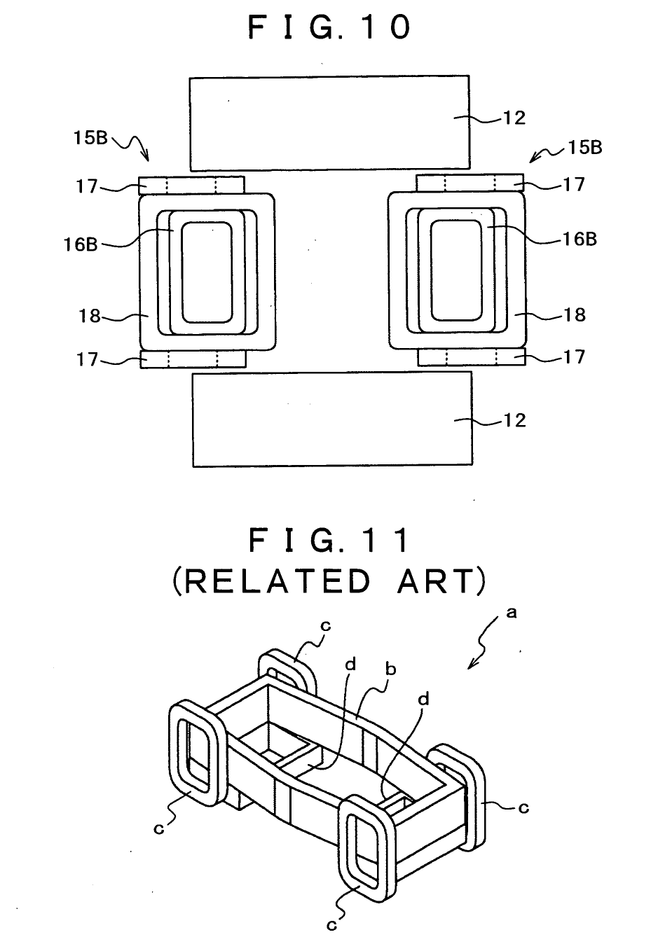

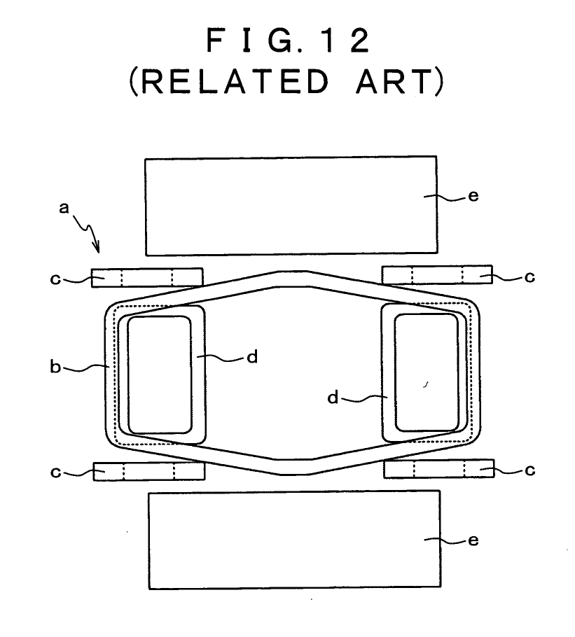

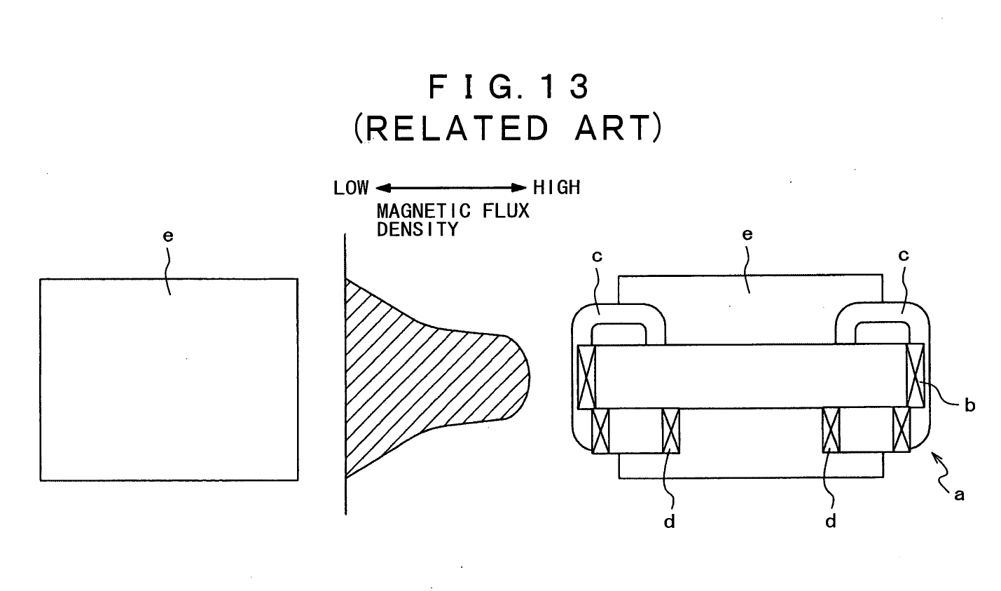

Next, a second modification of the coil assembly is described (see FIGS. 8 to 10). It is note, as compared with the above-mentioned coil assembly 15, a coil assembly 15B according to the second modification differs therefrom only in that paired focusing coils are provided. Thus, portions of the coil assembly 15B, which differ from the coil assembly 15 in comparison therewith, are described in detail. The remaining portions thereof are designated by the same reference characters as those used for designating similar parts of the coil assembly 15. Thus, the description of the remaining portions thereof is omitted.

The coil assembly 15B has a pair of focusing coils 16B, 16B and is constituted by connecting the tracking coils 17, 17, . . . and the tilt coils 18, 18 to the focusing coils 16B, 16B. The focusing coils 16B, 16B are disposed to be laterally separated from each other, and placed at positions corresponding to both the left and right end portions of the magnets 12, 12. The tilt coils 18, 18 are attached to the inner peripheral surfaces of the focusing coils 16B, 16B. The tracking coils 17, 17, are attached to both a front face and a rear face of the outer peripheral surfaces of the focusing coils 16B, 16B.

In the coil assembly 15B, the focusing coils 16B, 16B are disposed to be laterally separated from each other. Thus, for instance, a light passage 9c is formed by cutting out one yoke portion 9b existing at the side of an optical path of laser light, as illustrated in FIG. 9. Then, a rising mirror 21 is disposed in a space formed between the focusing coils 16B, 16B. Thus, the optical path of laser light can be upwardly moved and brought closer to the movable block 11. Consequently, the thickness of the optical pickup 6 can be reduced.

Incidentally, in the coil assembly 15B, the tilt coils 18, 18 are disposed in the focusing coils 16B, 16B. Conversely, the coil assembly may be constituted so that the focusing coils 16B, 16B are disposed in the tilt coils 18, 18. In this case, the tracking coils 17, 17, are attached onto the outer peripheral surfaces of the tilt coils 18, 18.

In the foregoing description, the present invention has been described by assuming that the focusing direction is an up-down direction, and that the tracking direction is a lateral direction. However, these directions exemplify the focusing direction and the tracking direction, for convenience of description. The focusing direction and the tracking direction are not necessarily limited to these directions.

The concrete shape and structure of each of parts shown in the above-mentioned preferred embodiments of the present invention are merely examples for carrying out the present invention. The technical scope of the invention should not be interpreted in a limited sense by these examples.

1. An optical pickup having a moving base being moved in a radial direction of a disklike recording medium loaded on a disc table and an objective lens drive disposed on the moving base, wherein:
said objective lens drive comprises:
a stationary block fixed to said moving base;
a movable block operated in a focusing direction that is a direction of bringing said movable block away from or closer to a recording surface of the disklike recording medium, in a tracking direction that is a substantially radial direction of the disklike recording medium, and in a tilting direction that is an axial direction of an axis perpendicular to both the focusing direction and the tracking direction, and for holding said objective lens;
a supporting spring for connecting said stationary block and said movable block;
a coil assembly having therein a focusing coil, tracking coils and tilt coils to be respectively energized when said movable block is operated in the focusing direction, the tracking direction, and the tilting direction connected together; and
magnets constituting a magnetic circuit together with each of said coils, and
said tilt coils are disposed at a position where at least a part thereof overlaps with said focusing coil in the focusing direction.

2. The optical pickup according to claim 1, wherein said tilt coils are attached on an inner surface of said focusing coil.

3. The optical pickup according to claim 1, wherein said tilt coils are attached on an outer surface of said focusing coil.

4. The optical pickup according to claim 1, wherein said coil assembly is provided in pair to be separated in the tracking direction.

5. A disc drive having a disc table on which a disklike storage medium is loaded and an optical pickup for irradiating a laser light onto the disklike recording medium loaded on the disc table through an objective lens, wherein:
said optical pickup has:
a moving base being moved in a radial direction of the disklike recording medium loaded on said disc table; and
an objective lens drive disposed on said moving base,
said objective lens drive comprises:
a stationary block fixed to said moving base;
a movable block operated in a focusing direction that is a direction of bringing said movable block away from or closer to a recording surface of a disklike recording medium, in a tracking direction that is a substantially radial direction of the disklike recording medium, and in a tilting direction that is an axial direction of an axis perpendicular to both the focusing direction and the tracking direction, and for holding said objective lens;
a supporting spring for connecting said stationary block and said movable block;
a coil assembly having therein a focusing coil, tracking coils and tilt coils to be respectively energized when said movable block is operated in the focusing direction, the tracking direction, and the tilting direction connected together; and
magnets constituting a magnetic circuit together with each of said coils, and
said tilt coils are disposed at a position where at least a part overlaps with said focusing coil in the focusing direction.

6. The disc drive according to claim 5, wherein said tilt coils are attached on an inner surface of said focusing coil.

7. The disc drive according to claim 5, wherein said tilt coils are attached on an outer surface of said focusing coil.

8. The disc drive according to claim 5, wherein said coil assembly is provided in pair to be separated in the tracking direction.
